(19) United States
(12) Patent Application Publication
(10) Pub. No.: US 2008/0218900 A1
(43) Pub. Date: Sep. 11, 2008

(54) MULTI-CHANNEL THIN-FILM MAGNETIC HEAD AND MAGNETIC TAPE DRIVE APPARATUS WITH THE MULTI-CHANNEL THIN-FILM MAGNETIC HEAD

(75) Inventors: Nozomu Hachisuka, Tokyo (JP); Tetsuya Hiraki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK CORPORATION, Tokyo (JP)

(21) Appl. No.: 11/684,193

(22) Filed: Mar. 9, 2007

(51) Int. Cl. G11B 5/008; G11B 5/127; G11B 5/33

(52) U.S. Cl. 360/90; 360/110; 360/327

(57) ABSTRACT

A multi-channel thin-film magnetic head has magnetic read head elements, magnetic write head elements, servo magnetic head elements, a plurality of pairs of external connection pads for reading connected with magnetic read head elements, a plurality of pairs of external connection pads for writing connected with magnetic write head elements, a plurality of pairs of external connection pads for servo connected with servo magnetic head elements, and a plurality of connection pads for body grounding or other functions. The connection pads for reading, writing, servo and body grounding or other functions are arranged in lines on a surface of the multi-channel thin-film magnetic head, and lead conductors which are electrically connected with connection pads for reading, writing, servo and body grounding or other functions are different each other in terms of widths, shapes, connection points or existence of a connector among at least two types of connection pads.

### BACKGROUND OF THE INVENTION

1. Field of the Invention

The present invention relates to a multi-channel thin-film magnetic head, and to a magnetic tape drive apparatus with the multi-channel thin-film magnetic head.

2. Description of the Related Art

A multi-channel thin-film magnetic head, which has a plurality of read head elements and write head elements for each channel, is used for a multi-channel magnetic tape drive apparatus. For example, a multi-channel thin-film magnetic head for a multi-channel magnetic tape drive apparatus in accordance with 3^{rd} generation linear tape open (LTO) standard has sixteen read head elements for sixteen channels, sixteen write head elements for sixteen channels, two servo magnetic head elements for two channels and four connection pads for body grounding.

Generally, a resistance of a head element, an electrical characteristic such as capacitance, a magnetic characteristic such as magnetization loop, an electromagnetic conversion characteristic and so on are measured and evaluated at each stage of a manufacturing process of thin-film magnetic heads. For the measurement, a pair of measuring probes is pressed against a pair of terminal pads of a thin-film magnetic head for detecting a signal from the head element.

Because a number of terminal pads, i.e. external connection pads, are extremely large in case of a multi-channel thin-film magnetic head, it is very difficult to distinguish terminal pads to a head element to be measured and to press measuring probes to the terminal pads by visual observation in case of measuring. For example, a multi-channel thin-film magnetic head in accordance with 3^{rd} generation LTO standard has thirty-two external connection pads for reading, thirty-two external connection pads for writing, four external connection pads for servo and four connection pads for grounding, i.e. it has seventy-two connection pads in total. Furthermore, a number of connection pads are double for a multi-channel thin-film magnetic head that can be applied for two generations, and therefore it is almost impossible to distinguish each terminal by visual observation.

Japanese patent publication No. 2005-322366A discloses a thin-film magnetic head having terminal pads for a magnetic disk. The shapes and dimensions of terminal pads are differentiated each other to distinguish polarity easily by visual observation.

However, the technique disclosed in the Japanese patent publication relates to a thin-film magnetic head of floating type that has maximum four terminal pads, and to distinguish a polarity of terminal pads corresponding to a polarity of a head element by visual observation. That is, the technique disclosed in the Japanese patent publication does not relate to a multi-channel thin-film magnetic head that has a plurality of terminal pads or external connection pads, which are arranged in lines. It is very difficult to use different shapes for external connection pads, which are arranged in lines, of the multi-channel thin-film magnetic head as disclosed in the Japanese patent publication because of its room. Furthermore, leading conductors of flexible printed circuit board (FPC) are connected with external connection pads. Because terminals of FPC have the same shapes, it causes a lack of compatibility with FPC to use different shapes for each external connection pads.

### SUMMARY OF THE INVENTION

It is therefore an object of the present invention to provide a multi-channel thin-film magnetic head and a magnetic tape drive apparatus that have a plurality of external connection pads, in which functions of them can be easily distinguished by visual observation, i.e. whether a connection pad is for reading, writing, servo, body grounding or other functions for future implementation.

According to the present invention, a multi-channel thin-film magnetic head has a plurality of magnetic read head elements, a plurality of pairs of external connection pads for reading, each of which electrically connects with each magnetic read head element, a plurality of magnetic write head elements, a plurality of pairs of external connection pads for writing, each of which electrically connects with each magnetic write head element, a plurality of servo magnetic head elements, a plurality of pairs of external connection pads for servo, each of which electrically connects with each servo magnetic head element, and a plurality of connection pads for body grounding or other functions. The external connection pads for reading, the external connection pads for writing, the external connection pads for servo and the connection pads for body grounding or other functions are arranged in one or more lines on a surface of the multi-channel thin-film magnetic head, and lead conductors which are electrically connected with external connection pads for reading, external connection pads for writing, external connection pads for servo and connection pads for body grounding or other functions are different each other in terms of widths, shapes, connection points or existence of a connector among at least two types of connection pads.

Because widths, shapes, connection points or connector existence of lead conductors connected to connection pads are differentiated each other, it is easy to distinguish whether connection pads are for reading, for writing, for servo or for body grounding/other functions by visual observation. Because widths, shapes, connection points or existence of a connector of lead conductors are differentiated, the same shapes and dimensions can be used for connection pads, and it can use space effectively and does not waste it. Because of the same shapes of connection pads, it does not cause the difference of signal transmission.

According to the invention, a multi-channel thin-film magnetic head has a plurality of magnetic read head elements, a plurality of pairs of external connection pads for reading, each of which electrically connects with each magnetic read head element, a plurality of magnetic write head elements, a plurality of pairs of external connection pads for writing, each of which electrically connects with each magnetic write head element, a plurality of servo magnetic head elements, a plurality of pairs of external connection pads for servo, each of which electrically connects with each servo magnetic head element, and a plurality of connection pads for body grounding or other functions. The external connection pads for reading, the external connection pads for writing, the external connection pads for servo and the connection pads for body grounding or other functions are arranged in one or more lines on a surface of the multi-channel thin-film magnetic head, and a mark or area identifying mark is formed on the surface between an area including the external connection pads for reading and an area including the external connection pads for writing for distinguishing both areas.

Because the mark is formed between the area for the external connection pads for reading and the area for the external connection pads for writing to distinguish each area, it is easy to distinguish whether connection pads are for reading or for writing by visual observation. Because it just forms the identifying mark between the areas, the same shapes and dimensions can be used for connection pads, and it is possible to use space effectively and does not waste it. The same shapes of connection pads do not cause the difference of signal transmission.

Favorably the external connection pads for reading, the external connection pads for writing, the external connection pads for servo and the connection pads for grounding or other functions have the same shapes and dimensions, and are arranged in a line.

Favorably the magnetic read head elements are magnetoresistive effect (MR) read head elements, and marks for indicating a polarity of sense current for each magnetoresistive effect read head element are formed on the surface near external connection pads for reading which are one of each pair.

Favorably identifiers for identifying the external connection pads for writing, the external connection pads for reading, the external connection pads for servo and/or the connection pads for body grounding or other functions are formed on the surface.

Advantageously the identifiers are numbers or marks for indicating addresses.

Advantageously the multi-channel thin-film magnetic head further includes a plurality of different generation magnetic read head elements, a plurality of pairs of different generation external connection pads for reading, each of which electrically connects with each different generation magnetic read head element, a plurality of different generation magnetic write head elements, a plurality of pairs of different generation external connection pads for writing, each of which electrically connects with each different generation magnetic write head element, a plurality of different generation servo magnetic head elements, a plurality of pairs of different generation external connection pads for servo, each of which electrically connects with each different generation servo magnetic head element, and a plurality of different generation connection pads for body grounding or other functions. The different generation magnetic read head elements, the different generation external connection pads for reading, the different generation magnetic write head elements, the different generation external connection pads for writing, the different generation servo magnetic head elements, the different generation external connection pads for servo and the different generation connection pads for body grounding or other function are in accordance with different generation magnetic tape standard from the magnetic read head elements, the external connection pads for reading, the magnetic write head elements, the external connection pads for writing, the servo magnetic head elements, the external connection pads for servo and the connection pads for body grounding or other functions, and shapes of the different generation external connection pads for reading, the different generation external connection pads for writing, the different generation external connection pads for servo and the different generation connection pads for body grounding or other functions are different from ones of the external connection pads for reading, the external connection pads for writing, the external connection pads for servo and the connection pads for body grounding or other functions.

According to the invention, a magnetic tape drive apparatus includes the multi-channel thin-film magnetic head describe above, a magnetic tape which faces the multi-channel thin-film magnetic head, and a drive system which moves the magnetic tape relatively with respect to the multi-channel thin-film magnetic head.

Further objects and advantages of the present invention will be apparent from the following description of the preferred embodiments of the invention as illustrated in the accompanying drawings.

### BRIEF DESCRIPTION OF THE DRAWINGS

FIG. 1 is a perspective view schematically illustrating a configuration of a multi-channel magnetic tape drive apparatus as a preferred embodiment according to the present invention;

FIG. 2 is an enlarged perspective view illustrating a multi-channel thin-film magnetic head shown in FIG. 1 and its surroundings;

FIG. 3 is a perspective view schematically illustrating a configuration of the multi-channel thin-film magnetic head shown in FIG. 1;

FIG. 4 is a plain view illustrating an arrangement of external connection pads of the multi-channel thin-film magnetic head shown in FIG. 1;

FIGS. 5a to 5d are plain views illustrating lead conductors connected to external connection pads of the multi-channel thin-film magnetic head shown in FIG. 1 and its modified embodiment;

FIG. 6 is a plain view illustrating an arrangement of external connection pads of the multi-channel thin-film magnetic head according to another embodiment of the invention;

FIG. 7 is a plain view illustrating an arrangement of external connection pads of the multi-channel thin-film magnetic head according to still another embodiment of the invention;

FIG. 8 is an explanatory drawing of identifiers for identifying each head element of the multi-channel thin-film magnetic head shown in FIG. 7;

FIG. 9 is a plain view illustrating an arrangement of external connection pads of the multi-channel thin-film magnetic head according to still another embodiment of the invention; and

FIG. 10 is a plain view illustrating an arrangement of external connection pads of the multi-channel thin-film magnetic head according to still another embodiment of the invention.

### DESCRIPTION OF THE PREFERRED EMBODIMENTS

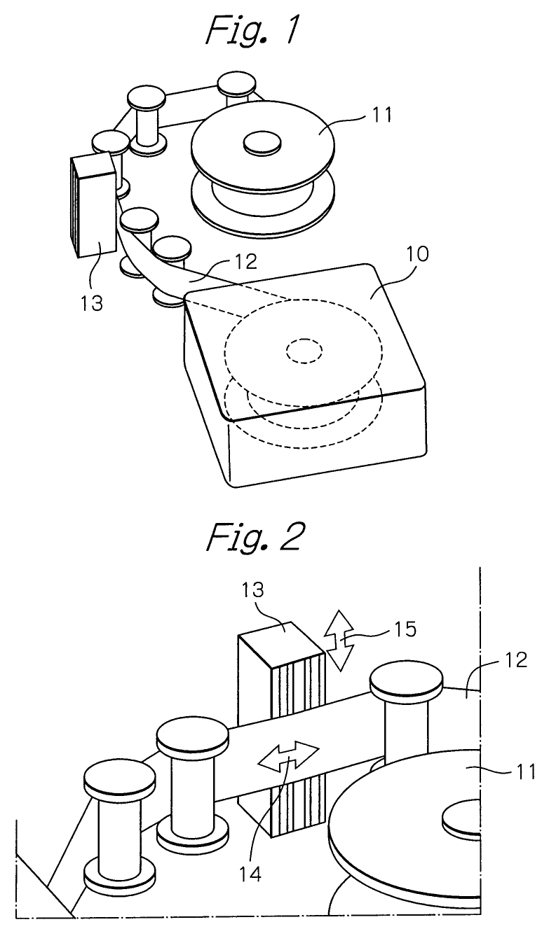

FIG. 1 schematically illustrates a configuration of a multi-channel magnetic tape drive apparatus as a preferred embodiment according to the present invention, and FIG. 2 is an enlarged perspective view illustrating a multi-channel thin-film magnetic head shown in FIG. 1 and its surroundings.

In this embodiment, the present invention applies for a 3^{rd} generation LTO magnetic tape drive apparatus. However, it should be noted that applications of the present invention are not limited to such LTO tape drive apparatus but the present invention can apply for any multi-channel tape drive apparatuses, any multi-channel disk drive apparatuses and any multi-channel drum drive apparatuses.

In FIGS. 1 and 2, reference numeral 10 denotes a tape cartridge with a single reel, 11 denotes a take-up reel for temporarily reeling a multi-channel magnetic tape 12 taken from the tape cartridge 10, and 13 denotes a multi-channel thin-film magnetic head capable of reciprocally moving in track-width directions or directions 15 perpendicular to the running directions 14 of the multi-channel magnetic tape 12, respectively.

As is known, in the LTO system, information is read from and/or written into the magnetic tape 12 with the ½-inch width. Thus, the multi-channel thin-film magnetic head 13 has a sixteen channels magnetic read head elements, sixteen channels magnetic write head elements and two channels servo magnetic head elements.

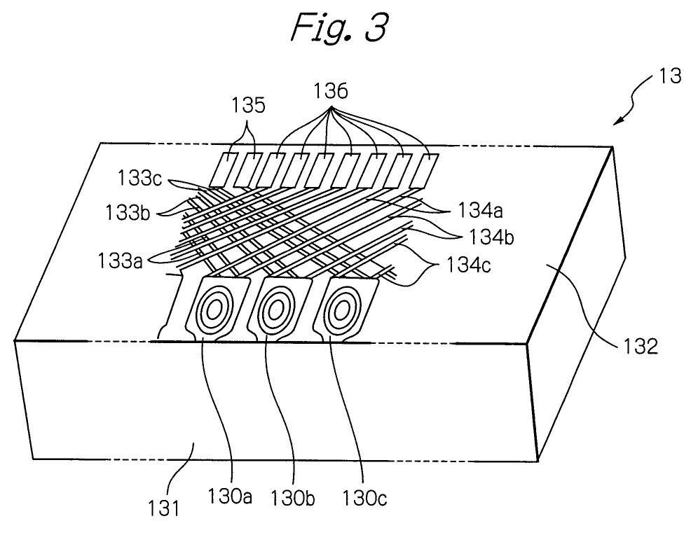

FIG. 3 schematically illustrates a configuration of the multi-channel thin-film magnetic head 13 of this embodiment. In the figure, only three magnetic read/write head elements are illustrated and the remaining magnetic read/write head elements, servo magnetic head elements and a layer laminated on these magnetic read/write head elements are omitted from illustration in order to easily understand.

In the figure, reference numerals 130a, 130b and 130c denote three magnetic read/write head elements out of sixteen aligned along the track-width direction in a plane 132 perpendicular to a tape bearing surface (TBS) 131, 133a, 133b and 133c denote lead conductors for electrically connecting the magnetic write head elements in head elements 130a, 130b and 130c, 134a, 134b and 134c denote lead conductors for electrically connecting the magnetic read head elements in head elements 130a, 130b and 130c, 135 denotes sixteen pairs of external connection pads for writing, which are connected with magnetic write head elements via lead conductors, and 136 denotes sixteen pairs of external connection pads for reading, which are connected with magnetic read head elements via lead conductors, respectively.

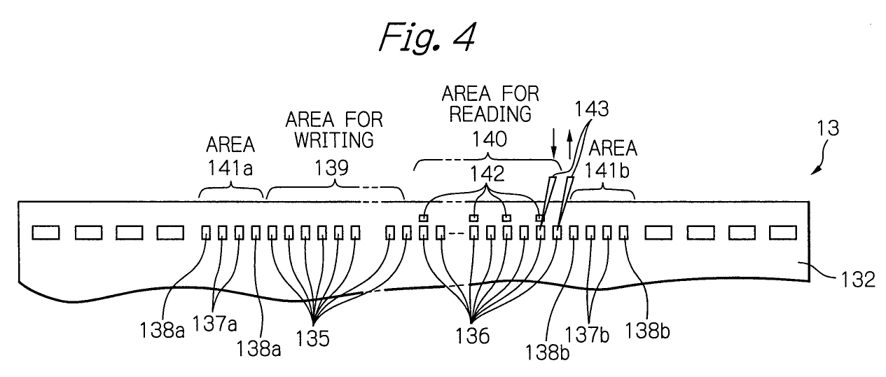

FIG. 4 is a plain view illustrating an arrangement of external connection pads of the multi-channel thin-film magnetic head 13 according to the embodiment.

As shown in FIG. 4, sixteen pairs of or thirty-two external connection pads 135 for writing, sixteen pairs of or thirty-two external connection pads 136 for reading, two pairs of or four external connection pads 137a and 137b for servo and four connection pads 138a and 138b for body grounding are arranged in a line on the plane 132 perpendicular to the TBS 131 of the multi-channel thin-film magnetic head 13 in the embodiment. In other words, sixteen pairs of external connection pads 135 are arranged in a line in a area 139, sixteen pairs of external connection pads 136 for reading are arranged in a line in a area 140 adjacent to the area 139, a connection pad 138a for body grounding, a pair of external connection pads 137a for servo and another connection pad 138a for body grounding are arranged in a line in a area 141a located outside of the area 139, and a connection pad 138b for body grounding, a pair of external connection pads 137b for servo and another connection pad 138b for body grounding are arranged in a line in a area 141b located outside of the area 140. According to the modified embodiment of the invention, the connection pads 138a and 138b for body grounding can be used for other functions such that electrical current for driving a heater or predetermined voltage is applied.

According to the embodiment, geometrical shapes and dimensions of external connection pads 135 for writing, external connection pads 136 for reading, external connection pads 137a and 137b for servo and connection pads 138a and 138b for body grounding are the same.

Furthermore, according to the embodiment, marks 142 for identifying a polarity are attached near external connection pads 136, which are one of each pair for reading, to indicate the polarity of read head elements that each pair of connection pads 136 are connected to. For example, a giant magnetoresistive (GMR) effect head element can be divided two types based on whether the magnetic field caused by the sense current has the same direction (assist) or opposite direction (against) as net moment of its pinning layer, and the polarity of the sense current is determined by the type. For example, the marks 142 for identifying a polarity is formed near external connection pads 136, polarity of which are positive. Off course the marks 142 for identifying a polarity can be formed near external connection pads 136, polarity of which are negative.

The marks 142 for identifying a polarity can be formed using the same material as the one for the external connection pads, or using the different material, which is visible.

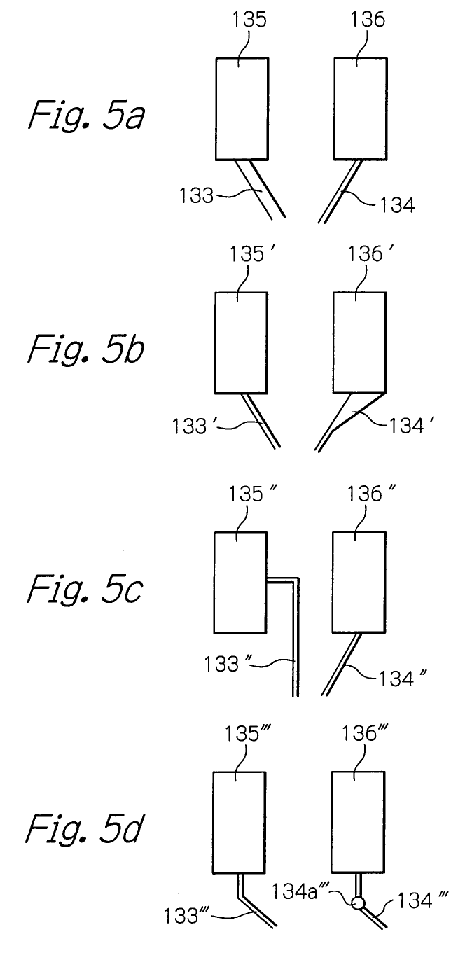

FIGS. 5a to 5d are plain views illustrating lead conductors connected to external connection pads of the multi-channel thin-film magnetic head according to the embodiment and its modified embodiments. In this figures, only two external connection pads, which are connected with different magnetic head elements respectively, are indicated to facilitate understanding.

According to the embodiment, the shapes and dimensions of connection pads are the same, but the width of lead conductors that are connected to a external connection pad 135 for writing and a external connection pad 136 for reading are different each other as shown in FIG. 5a. More concretely, the width of a lead conductor 133 connected to the external connection pad 135 for writing is thicker than the one of a lead conductor 134 connected to the external connection pad 136 for reading. It is possible to identify the function of each external connection pad, which depends on a corresponding magnetic head, i.e. external connection pad 135 for writing or external connection pad 136 for reading, easily by visual observation with this configuration, even though connection pads have the same shapes and dimensions. The functions of external connection pads to be distinguished may be combination of the two, three or four among writing, reading, servo and grounding.

According to a modified embodiment, the shapes and dimensions of connection pads are the same, but the shapes of a lead conductor 133′ connected to an external connection pad 135′ for writing and a lead conductor 134′ connected to a external connection pad 136′ for reading are different each other as shown in FIG. 5b.

According to a still modified embodiment, the shapes and dimensions of connection pads are the same, but the connecting points of a lead conductor 133″ with a external connection pad 135″ for writing and a lead conductor 134″ with an external connection pad 136″ for reading are different each other as shown in FIG. 5c.

According to a still modified embodiment, the shapes and dimensions of connection pads are the same, but a lead conductor 133″′ connected to a external connection pad 135″′ for writing or a lead conductor 134″′ connected to a external connection pad 136″′ for reading has a connector part 134a″′, while another lead conductor 133″′ or 134″′ does not have it as shown in FIG. 5d.

As described above, according to the embodiment and its modified embodiments, because the widths, shapes, connection points or connector existence of lead conductors are different each other based on the function of external connection pads that the lead conductors are connected with, i.e. the external connection pad 135 for writing or the external connection pad 136 for reading, it is very easy to identify the function of external connection pads by visual observation. This is effective for measurement, which is performed by pressing measuring probes 143 shown in FIG. 4 against connection pads for a desired head element, especially for multi-channel thin-film magnetic heads that have a plurality of connection pads in accordance with LTO, and it can reduce mistakes and shorten measuring time. Furthermore, because the same shapes and dimensions can be used for connection pads, it can use space effectively and does not waste it. The same shapes of connection pads do not cause the difference of signal transmission. Because the external connection pads are generally connected with FPC, which has the same terminal shapes, the compatibility of connection is good.

Further direction of the electrical current applied to external connection pads can be easily identified by the mark 142 as shown in FIG. 4, and it can shorten the measuring time, because it can prevent the mistake such as wrong connection of measuring probes 143, and it does not require two times measurement by applying the sense current for both direction.

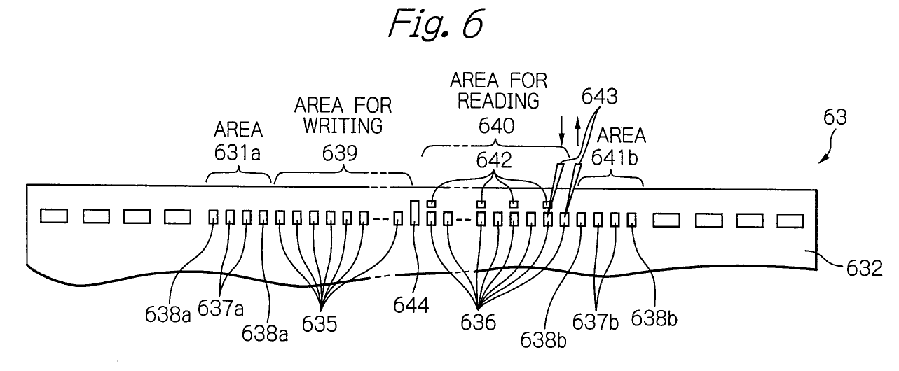

FIG. 6 is a plain view illustrating an arrangement of external connection pads of the multi-channel thin-film magnetic head according to another embodiment of the invention. According to the embodiment, the configuration is the same as the one shown in FIGS. 1 to 5a, except a mark for identifying each area is provided and lead conductors are the same in terms of shapes, width and so on.

As shown in FIG. 6, sixteen pairs of or thirty-two external connection pads 635 for writing, sixteen pairs of or thirty-two external connection pads 636 for reading, two pairs of or four external connection pads 637a and 637b for servo and four connection pads 638a and 638b for body grounding are arranged in a line on a plane 632 perpendicular to the TBS in the embodiment. In other words, sixteen pairs of external connection pads 635 are arranged in a line in a area 639, sixteen pairs of external connection pads 636 for reading are arranged in a line in a area 640 adjacent to the area 639, a connection pad 638a for body grounding, a pair of external connection pads 637a for servo and another connection pad 638a for body grounding are arranged in a line in a area 641a located outside of the area 639, and a connection pad 638b for body grounding, a pair of external connection pads 637b for servo and another connection pad 638b for body grounding are arranged in a line in a area 641b located outside of the area 640.

In the embodiment, geometrical shapes and dimensions of external connection pads 635 for writing, external connection pads 636 for reading, external connection pads 637a and 637b for servo and connection pads 638a and 638b for body grounding are the same. Further, lead conductors, which are connected with external connection pads 635 for writing, external connection pads 636 for reading, external connection pads 637a and 637b for servo and connection pads 638a and 638b for body grounding are the same in terms of widths, shapes, connection points and existence of a connector.

According to the embodiment, a mark 644 for identifying an area are provided between the area 639, which has external connection pads 635 for writing, and the area 640, which has external connection pads 636 for reading.

Furthermore, according to the embodiment, marks 642 for identifying a polarity are attached near external connection pads 636, which are one of each pair for reading, to indicate the polarity of read head elements that each pair of connection pads 636 are connected to. For example, a giant magnetoresistive (GMR) effect head element can be divided two types based on whether the magnetic field caused by the sense current has the same direction (assist) or opposite direction (against) as net moment of its pinning layer, and the polarity of the sense current is determined by the type. For example, the marks 642 for identifying a polarity is formed only near external connection pads 636, polarity of which are positive. Off course the marks 642 for identifying a polarity can be formed only near external connection pads 636, polarity of which are negative.

The mark 644 for identifying an area and the marks 642 for identifying a polarity can be formed using the same material as the one for the external connection pads or using the different material that is visible. Further, marks can be formed by processing the substrate of the magnetic head.

As described above, according to the embodiment, because the mark 644 for identifying an area are provided between areas, in which functions of external connection pads are different each other, for example the area 639 for external connection pads 635 for writing and the area 640 for external connection pads 636 for reading, it is very easy to identify the function of external connection pads by visual observation. This is effective for measurement, which is performed by pressing measuring probes 643 against connection pads for a desired head element, especially for multi-channel thin-film magnetic heads that have a plurality of connection pads in accordance with LTO, and it can reduce mistakes and shorten measuring time. Furthermore, it can use space effectively and does not waste it, because the same shapes and dimensions can be used for connection pads. The same shapes of connection pads do not cause the difference of signal transmission. Because the connection pads are generally connected with FPC, which has the same terminal shapes, the compatibility of connection is good.

Further direction of the electrical current applied to external connection pads can be easily identified by the mark 642, and it can shorten measuring time, because it can prevent the mistake such as wrong connection of measuring probes 643, and it does not require two times measurement by applying the sense current for both direction.

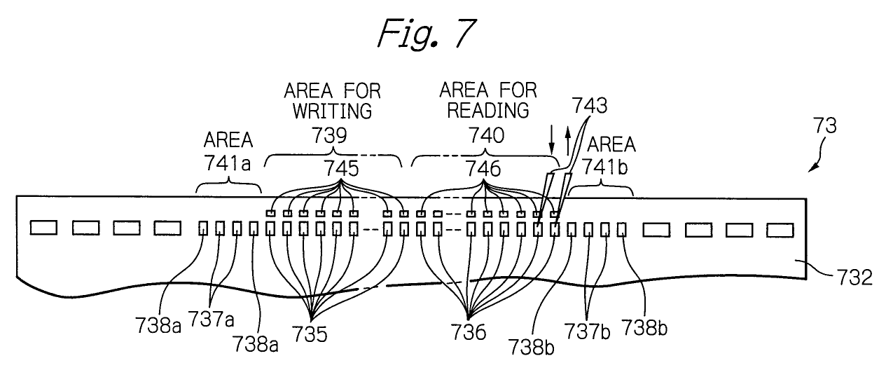

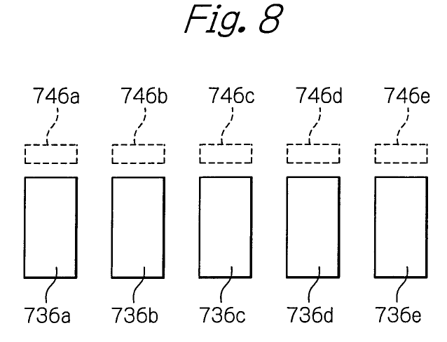

FIG. 7 is a plain view illustrating an arrangement of external connection pads of the multi-channel thin-film magnetic head according to still another embodiment of the invention, and FIG. 8 is an explanatory drawing of identifiers, which are used to identify each head element of the multi-channel thin-film magnetic head. According to the embodiment, the configuration is the same as the one shown in FIGS. 1 to 5a and FIGS. 5b to 5d, except identifiers for addressing magnetic read head elements, magnetic write head elements or servo magnetic head elements near external connection pads connected with them.

As shown in FIG. 7, sixteen pairs of or thirty-two external connection pads 735 for writing, sixteen pairs of or thirty-two external connection pads 736 for reading, two pairs of or four external connection pads 737a and 737b for servo and four connection pads 738a and 738b for body grounding are arranged in a line on a plane 732 perpendicular to the TBS according the embodiment. In other words, sixteen pairs of external connection pads 735 are arranged in a line in a area 739, sixteen pairs of external connection pads 736 for reading are arranged in a line in a area 740 adjacent to the area 739, a connection pad 738a for body grounding, a pair of external connection pads 737a for servo and another connection pad 738a for body grounding are arranged in a line in a area 741a located outside of the area 739, and a connection pad 738b for body grounding, a pair of external connection pads 737b for servo and another connection pad 738b for body grounding are arranged in a line in a area 741b located outside of the area

According to the embodiment, geometrical shapes and dimensions of external connection pads 735 for writing, external connection pads 736 for reading, external connection pads 737a and 737b for servo and connection pads 738a and 738b for body grounding are the same. However, lead conductors that are connected to external connection pads 735 for writing, external connection pads 736 for reading, external connection pads 737a and 737b for servo and connection pads 738a and 738b for body grounding are different each other in terms of widths, shapes, connection point and/or existence of a connector.

Especially, address numbers or marks 745 and 746 that indicates an address for each magnetic head are attached near external connection pads 735 for writing and external connection pads 736 for reading, according to the embodiment.

More concretely, as shown in FIG. 8, address numbers 746a to 746e are formed to distinguish each pad near it, for example near external connection pads 736a to 736e for reading. Marks which have dots for identifying an address can be used instead of address numbers. Each external connection pads can be easily distinguished using address numbers or marks for identifying an address. Off course, polarity of sense current can be distinguished using address numbers or marks for identifying an address.

The address numbers or marks 745/746 for identifying an address can be formed using the same material as the one for the external connection pads or using the different material that is visible. Further, it is possible to form them by processing a substrate of the magnetic head.

As described above, according to the embodiment, because the widths, shapes, connection points or existence of a connector of lead conductors are different each other based on the function of connection pads, i.e. external connection pads 735 for writing or external connection pads 736 for reading, it is very easy to identify the function of external connection pads by visual observation. This is effective for measurement, which is performed by pressing measuring probes 743 shown in FIG. 7 against connection pads for a desired head element, especially for multi-channel thin-film magnetic heads that have a plurality of connection pads in accordance with LTO, and it can reduce mistakes and shorten measuring time. Furthermore, it can use space effectively and does not waste it, because the same shapes and dimensions can be used for connection pads. The same shapes of connection pads do not cause the difference of signal transmission. Because the external connection pads are generally connected with FPC, which has the same terminal shapes, the compatibility of connection is good.

Further, since address numbers or marks for identifying an address are attached near external connection pads 735 for writing and external connection pads 736 for reading, it is easy to distinguish each external connection pad.

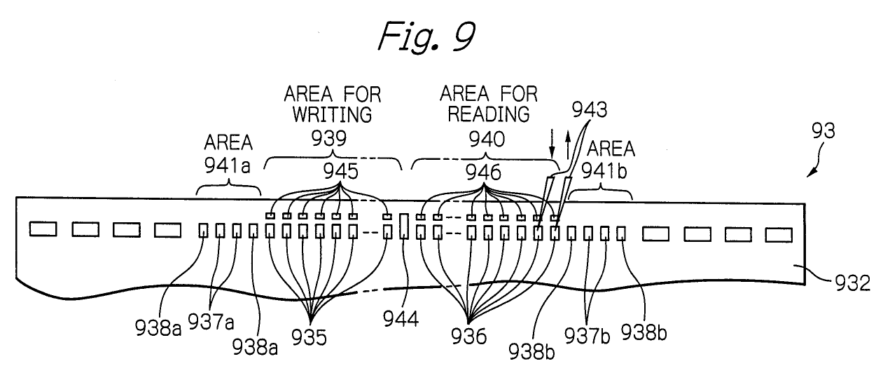

FIG. 9 is a plain view illustrating an arrangement of external connection pads of the multi-channel thin-film magnetic head according to still another embodiment of the invention. According to the embodiment, the configuration is the same as the one shown in FIG. 6, except identifiers for addressing magnetic read head elements, magnetic write head elements or servo magnetic head elements are provided near external connection pads.

As shown in FIG. 9, sixteen pairs of or thirty-two external connection pads 935 for writing, sixteen pairs of or thirty-two external connection pads 936 for reading, two pairs of or four external connection pads 937a and 937b for servo and four connection pads 938a and 938b for body grounding are arranged in a line on a plane 932 perpendicular to the TBS according the embodiment. In other words, sixteen pairs of external connection pads 935 are arranged in a line in a area 939, sixteen pairs of external connection pads 936 for reading are arranged in a line in a area 940 adjacent to the area 939, a connection pad 938a for body grounding, a pair of external connection pads 937a for servo and another connection pad 938a for body grounding are arranged in a line in a area 941a located outside of the area 939, and a connection pad 938b for body grounding, a pair of external connection pads 937b for servo and another connection pad 938b for body grounding are arranged in a line in a area 941b located outside of the area 940.

According to the embodiment, geometrical shapes and dimensions of external connection pads 935 for writing, external connection pads 936 for reading, external connection pads 937a and 937b for servo and connection pads 938a and 938b for body grounding are the same each other. Further, according to the embodiment, the widths, shapes, connection points and existence of a connector of lead conductors, which are connected with external connection pads 935 for writing, external connection pads 936 for reading, external connection pads 937a and 937b for servo and connection pads 938a and 938b for body grounding are the same each other.

According to the embodiment, a mark 944 for identifying an area is provided between the area 939, which has external connection pads 935 for writing, and the area 940, which has external connection pads 936 for reading.

Especially, address numbers or marks for indicating an address, which indicates each magnetic head, are attached near external connection pads 935 for writing and external connection pads 936 for reading, in the embodiment.

More concretely, address numbers are formed near external connection pads 935 for writing and external connection pads 936 for reading to distinguish them. Marks which have dots for identifying an address can be used instead of address numbers. Each external connection pads can be easily distinguished using address numbers or marks for identifying an address. Off course, polarity of sense current can be distinguished using address numbers or marks for identifying an address.

The mark 944 for identifying an area and address numbers or marks 945/946 for identifying an address can be formed using the same material as the one for the external connection pads or using the different material that is visible. Further, it is possible to form them by processing a substrate of the magnetic head.

As described above, according to the embodiment, because the mark 944 for identifying an area is provided between areas, in which function of external connection pads are different each other, for example the area 939 for external connection pads 935 for writing and the area 940 for external connection pads 936 for reading, it is very easy to identify the function of external connection pads by visual observation. This is effective for measurement, which is performed by pressing measuring probes 943 against connection pads for a desired head element, especially for multi-channel thin-film magnetic heads that have a plurality of connection pads in accordance with LTO, and it can reduce mistakes and shorten measuring time. Furthermore, it can use space effectively and does not waste it, because the same shapes and dimensions can be used for external connection pads. The same shapes of connection pads do not cause the difference of signal transmission. Because the external connection pads are generally connected with FPC, which has the same terminal shapes, the compatibility of connection is good.

Further, since address numbers or marks for identifying an address are attached near external connection pads 935 for writing and external connection pads 936 for reading, it is easy to distinguish each external connection pad.

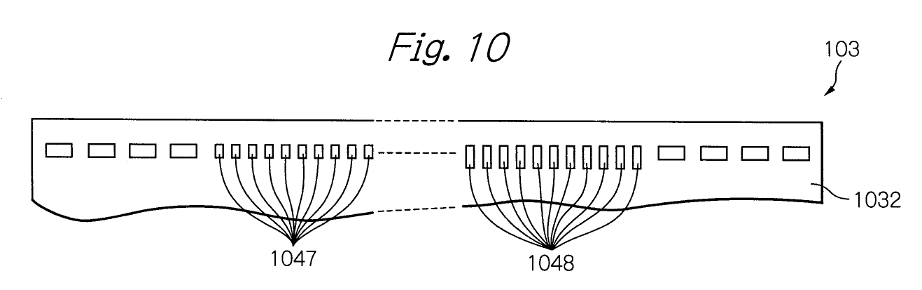

FIG. 10 is a plain view illustrating an arrangement of external connection pads of the multi-channel thin-film magnetic head according to still another embodiment of the invention. According to the embodiment, the configuration is the same as the one described above, except magnetic write head elements, magnetic read head elements and servo magnetic head elements, which are in accordance with different generation standards, are formed in one magnetic head, and shapes of external connection pads are different depends on a generation of magnetic head elements, which the pads are connected with.

As shown in FIG. 10, external connection pads 1047 for 3^{rd} generation standard, which includes sixteen pairs of or thirty-two external connection pads for writing, sixteen pairs of or thirty-two external connection pads for reading, two pairs of or four external connection pads for servo and four connection pads for body grounding, and external connection pads 1048 for next generation standard, which includes a plurality of external connection pads for writing, reading and servo and a plurality of connection pads for body grounding, are arranged in a line on a plane 1032 perpendicular to the TBS of the multi-channel thin-film magnetic head 103.

Geometrical shapes of external connection pads 1047 for 3^{rd} generation and the external connection pads 1048 for next generation are different each other, and it is easy to distinguish each generation. Other configuration is the same as one of the embodiment described above.

More concretely, address numbers are formed to distinguish each pad near each external connection pads 736 for reading. Marks which have dots for identifying an address can be used instead of address numbers. Each external connection pads can be easily distinguished using address numbers or marks for identifying an address. Off course, polarity of sense current can be distinguished using address numbers or marks for identifying an address.

As described above, according to the embodiment, because shapes of connection pads are different depends on generation, it is very easy to identify the generation by visual observation. This is effective for measurement, which is performed by pressing measuring probes 943 against external connection pads for a head element for desired generation, especially for multi-channel thin-film magnetic heads that have a plurality of connection pads in accordance with LTO, and it can reduce mistakes and shorten measuring time.

Many widely different embodiments of the present invention may be constructed without departing from the spirit and scope of the present invention. It should be understood that the present invention is not limited to the specific embodiments described in the specification, except as defined in the appended claims.

1. A multi-channel thin-film magnetic head, comprising:
a plurality of magnetic read head elements;
a plurality of pairs of external connection pads for reading, each pair of external connection pads for reading electrically connecting with each magnetic read head element;
a plurality of magnetic write head elements;
a plurality of pairs of external connection pads for writing, each pair of external connection pads for writing electrically connecting with each magnetic write head element;
a plurality of servo magnetic head elements;
a plurality of pairs of external connection pads for servo, each pair of external connection pads for servo electrically connecting with each servo magnetic head element; and
a plurality of connection pads for body grounding or other functions,
wherein the external connection pads for reading, the external connection pads for writing, the external connection pads for servo and the connection pads for body grounding or other functions are arranged in one or more lines on a surface of the multi-channel thin-film magnetic head, and
lead conductors which are electrically connected with external connection pads for reading, external connection pads for writing, external connection pads for servo and connection pads for body grounding or other functions are different each other in terms of widths, shapes, connection points or existence of a connector among at least two types of connection pads.

2. The multi-channel thin-film magnetic head according to claim 1, wherein the external connection pads for reading, the external connection pads for writing, the external connection pads for servo and the connection pads for grounding or other functions have the same shapes and dimensions, and are arranged in a line.

3. The multi-channel thin-film magnetic head according to claim 1, wherein the magnetic read head elements are magnetoresistive effect read head elements, and marks for indicating a polarity of sense current for each magnetoresistive effect read head element are formed on the surface near external connection pads for reading which are one of each pair.

4. The multi-channel thin-film magnetic head according to claim 1, wherein identifiers for identifying the external connection pads for writing, the external connection pads for reading, the external connection pads for servo and/or the connection pads for body grounding or other functions are formed on the surface.

5. The multi-channel thin-film magnetic head according to claim 4, wherein the identifiers are numbers or marks for indicating an address.

6. The multi-channel thin-film magnetic head according to claim 1, further comprising:
a plurality of different generation magnetic read head elements;
a plurality of pairs of different generation external connection pads for reading, each pair of different generation external connection pads for reading electrically connecting with each different generation magnetic read head element;
a plurality of different generation magnetic write head elements;
a plurality of pairs of different generation external connection pads for writing, each pair of different generation external connection pads for writing electrically connecting with each different generation magnetic write head element;
a plurality of different generation servo magnetic head elements;
a plurality of pairs of different generation external connection pads for servo, each pair of external connection pads for servo electrically connecting with each different generation servo magnetic head element; and
a plurality of different generation connection pads for body grounding or other functions,
wherein the different generation magnetic read head elements, the different generation external connection pads for reading, the different generation magnetic write head elements, the different generation external connection pads for writing, the different generation servo magnetic head elements, the different generation external connection pads for servo and the different generation connection pads for body grounding or other function are in accordance with different generation magnetic tape standard from the magnetic read head elements, the external connection pads for reading, the magnetic write head elements, the external connection pads for writing, the servo magnetic head elements, the external connection pads for servo and the connection pads for body grounding or other functions, and
shapes of the different generation external connection pads for reading, the different generation external connection pads for writing, the different generation external connection pads for servo and the different generation connection pads for body grounding or other functions are different from ones of the external connection pads for reading, the external connection pads for writing, the external connection pads for servo and the connection pads for body grounding or other functions.

7. A multi-channel thin-film magnetic head, comprising:
a plurality of magnetic read head elements;
a plurality of pairs of external connection pads for reading, each pair of external connection pads for reading electrically connecting with each magnetic read head element;
a plurality of magnetic write head elements;
a plurality of pairs of external connection pads for writing, each pair of external connection pads for writing electrically connecting with each magnetic write head element;
a plurality of servo magnetic head elements;
a plurality of pairs of external connection pads for servo, each pair of external connection pads for servo electrically connecting with each servo magnetic head element; and
a plurality of connection pads for body grounding or other functions,
wherein the external connection pads for reading, the external connection pads for writing, the external connection pads for servo and the connection pads for body grounding or other functions are arranged in one or more lines on a surface of the multi-channel thin-film magnetic head, and
a mark is formed on the surface between an area including the external connection pads for reading and an area including the external connection pads for writing for distinguishing both areas.

8. The multi-channel thin-film magnetic head according to claim 7, wherein the external connection pads for reading, the external connection pads for writing, the external connection pads for servo and the connection pads for grounding or other functions have the same shapes and dimensions, and are arranged in a line.

9. The multi-channel thin-film magnetic head according to claim 7, wherein the magnetic read head elements are magnetoresistive effect read head elements, and marks for indicating a polarity of sense current for each magnetoresistive effect read head element are formed on the surface near external connection pads for reading which are one of each pair.

10. The multi-channel thin-film magnetic head according to claim 7, wherein identifiers for identifying the external connection pads for writing, the external connection pads for reading, the external connection pads for servo and/or the connection pads for body grounding or other functions are formed on the surface.

11. The multi-channel thin-film magnetic head according to claim 10, wherein the identifiers are numbers or marks for indicating an address.

12. The multi-channel thin-film magnetic head according to claim 7, further comprising:
a plurality of different generation magnetic read head elements;
a plurality of pairs of different generation external connection pads for reading, each pair of different generation external connection pads for reading electrically connecting with each different generation magnetic read head element;
a plurality of different generation magnetic write head elements;
a plurality of pairs of different generation external connection pads for writing, each pair of different generation external connection pads for writing electrically connecting with each different generation magnetic write head element;
a plurality of different generation servo magnetic head elements;
a plurality of pairs of different generation external connection pads for servo, each pair of external connection pads for servo electrically connecting with each different generation servo magnetic head element; and
a plurality of different generation connection pads for body grounding or other functions,
wherein the different generation magnetic read head elements, the different generation external connection pads for reading, the different generation magnetic write head elements, the different generation external connection pads for writing, the different generation servo magnetic head elements, the different generation external connection pads for servo and the different generation connection pads for body grounding or other function are in accordance with different generation magnetic tape standard from the magnetic read head elements, the external connection pads for reading, the magnetic write head elements, the external connection pads for writing, the servo magnetic head elements, the external connection pads for servo and the connection pads for body grounding or other functions, and
shapes of the different generation external connection pads for reading, the different generation external connection pads for writing, the different generation external connection pads for servo and the different generation connection pads for body grounding or other functions are different from ones of the external connection pads for reading, the external connection pads for writing, the external connection pads for servo and the connection pads for body grounding or other functions.

13. A magnetic tape drive apparatus, comprising:
a multi-channel thin-film magnetic head;
a magnetic tape facing the multi-channel thin-film magnetic head; and
a drive system for moving the magnetic tape relatively with respect to the multi-channel thin-film magnetic head,
wherein the multi-channel thin-film magnetic head comprises:
a plurality of magnetic read head elements;
a plurality of pairs of external connection pads for reading, each pair of external connection pads for reading electrically connecting with each magnetic read head element;
a plurality of magnetic write head elements;
a plurality of pairs of external connection pads for writing, each pair of external connection pads for writing electrically connecting with each magnetic write head element;
a plurality of servo magnetic head elements;
a plurality of pairs of external connection pads for servo, each pair of external connection pads for servo electrically connecting with each servo magnetic head element; and
a plurality of connection pads for body grounding or other functions,
wherein the external connection pads for reading, the external connection pads for writing, the external connection pads for servo and the connection pads for body grounding or other functions are arranged in one or more lines on a surface of the multi-channel thin-film magnetic head, and
lead conductors which are electrically connected with external connection pads for reading, external connection pads for writing, external connection pads for servo and connection pads for body grounding or other functions are different each other in terms of widths, shapes, connection points or existence of a connector among at least two types of connection pads.

14. The magnetic tape drive apparatus according to claim 13, wherein the external connection pads for reading, the external connection pads for writing, the external connection pads for servo and the connection pads for grounding or other functions have the same shapes and dimensions, and are arranged in a line.

15. The magnetic tape drive apparatus according to claim 13, wherein the magnetic read head elements are magnetoresistive effect read head elements, and marks for indicating a polarity of sense current for each magnetoresistive effect read head element are formed on the surface near external connection pads for reading which are one of each pair.

16. The magnetic tape drive apparatus according to claim 13, wherein identifiers for identifying the external connection pads for writing, the external connection pads for reading, the external connection pads for servo and/or the connection pads for body grounding or other functions are formed on the surface.

17. The magnetic tape drive apparatus according to claim 16, wherein the identifiers are numbers or marks for indicating an address.

18. The magnetic tape drive apparatus according to claim 16, wherein the multi-channel thin-film magnetic head further comprises:
a plurality of different generation magnetic read head elements;
a plurality of pairs of different generation external connection pads for reading, each pair of different generation external connection pads for reading electrically connecting with each different generation magnetic read head element;
a plurality of different generation magnetic write head elements;
a plurality of pairs of different generation external connection pads for writing, each pair of different generation external connection pads for writing electrically connecting with each different generation magnetic write head element;
a plurality of different generation servo magnetic head elements;
a plurality of pairs of different generation external connection pads for servo, each pair of external connection pads for servo electrically connecting with each different generation servo magnetic head element; and
a plurality of different generation connection pads for body grounding or other functions,
wherein the different generation magnetic read head elements, the different generation external connection pads for reading, the different generation magnetic write head elements, the different generation external connection pads for writing, the different generation servo magnetic head elements, the different generation external connection pads for servo and the different generation connection pads for body grounding or other function are in accordance with different generation magnetic tape standard from the magnetic read head elements, the external connection pads for reading, the magnetic write head elements, the external connection pads for writing, the servo magnetic head elements, the external connection pads for servo and the connection pads for body grounding or other functions, and
shapes of the different generation external connection pads for reading, the different generation external connection pads for writing, the different generation external connection pads for servo and the different generation connection pads for body grounding or other functions are different from ones of the external connection pads for reading, the external connection pads for writing, the external connection pads for servo and the connection pads for body grounding or other functions.

19. A magnetic tape drive apparatus, comprising:
a multi-channel thin-film magnetic head;
a magnetic tape facing the multi-channel thin-film magnetic head; and
a drive system for moving the magnetic tape relatively with respect to the multi-channel thin-film magnetic head,
wherein the multi-channel thin-film magnetic head, comprising:
a plurality of magnetic read head elements;
a plurality of pairs of external connection pads for reading, each pair of external connection pads for reading electrically connecting with each magnetic read head element;
a plurality of magnetic write head elements;
a plurality of pairs of external connection pads for writing, each pair of external connection pads for writing electrically connecting with each magnetic write head element;
a plurality of servo magnetic head elements;
a plurality of pairs of external connection pads for servo, each pair of external connection pads for servo electrically connecting with each servo magnetic head element; and
a plurality of connection pads for body grounding or other functions,
wherein the external connection pads for reading, the external connection pads for writing, the external connection pads for servo and the connection pads for body grounding or other functions are arranged in one or more lines on a surface of the multi-channel thin-film magnetic head, and
a mark is formed on the surface between an area including the external connection pads for reading and an area including the external connection pads for writing for distinguishing both areas.

20. The magnetic tape drive apparatus according to claim 19, wherein the external connection pads for reading, the external connection pads for writing, the external connection pads for servo and the connection pads for grounding or other functions have the same shapes and dimensions, and are arranged in a line.

21. The magnetic tape drive apparatus according to claim 19, wherein the magnetic read head elements are magnetoresistive effect read head elements, and marks for indicating a polarity of sense current for each magnetoresistive effect read head elements are formed on the surface near external connection pads for reading which are one of each pair.

22. The magnetic tape drive apparatus according to claim 19, wherein identifiers for identifying the external connection pads for writing, the external connection pads for reading, the external connection pads for servo and/or the connection pads for body grounding or other functions are formed on the surface.

23. The magnetic tape drive apparatus according to claim 22, wherein the identifiers are numbers or marks for indicating an address.

24. The magnetic tape drive apparatus according to claim 19, wherein the multi-channel thin-film magnetic head further comprises:
a plurality of different generation magnetic read head elements;
a plurality of pairs of different generation external connection pads for reading, each pair of different generation external connection pads for reading electrically connecting with each different generation magnetic read head element;
a plurality of different generation magnetic write head elements;
a plurality of pairs of different generation external connection pads for writing, each pair of different generation external connection pads for writing electrically connecting with each different generation magnetic write head element;
a plurality of different generation servo magnetic head elements;
a plurality of pairs of different generation external connection pads for servo, each pair of external connection pads for servo electrically connecting with each different generation servo magnetic head element; and
a plurality of different generation connection pads for body grounding or other functions,
wherein the different generation magnetic read head elements, the different generation external connection pads for reading, the different generation magnetic write head elements, the different generation external connection pads for writing, the different generation servo magnetic head elements, the different generation external connection pads for servo and the different generation connection pads for body grounding or other function are in accordance with different generation magnetic tape standard from the magnetic read head elements, the external connection pads for reading, the magnetic write head elements, the external connection pads for writing, the servo magnetic head elements, the external connection pads for servo and the connection pads for body grounding or other functions, and
shapes of the different generation external connection pads for reading, the different generation external connection pads for writing, the different generation external connection pads for servo and the different generation connection pads for body grounding or other functions are different from ones of the external connection pads for reading, the external connection pads for writing, the external connection pads for servo and the connection pads for body grounding or other functions.
